(19) United States
(12) Patent Application Publication
(10) Pub. No.: US 2026/0120227 A1
(43) Pub. Date: Apr. 30, 2026

(54) CONTROL METHOD AND CONTROL APPARATUS

(71) Applicant: Smarter Silicon (Shanghai) Technologies Co., Ltd., Shanghai (CN)

(72) Inventors: Zhuojin SUN, Shanghai (CN); Huafei QI, Shanghai (CN)

(21) Appl. No.: 19/370,731

(22) Filed: Oct. 27, 2025

(30) Foreign Application Priority Data
Oct. 31, 2024 (CN) 202411546501.X

(51) Int. Cl. G06T 1/20

(52) U.S. Cl. CPC G06T 1/20

(57) ABSTRACT

A control method includes obtaining lengths of historical rendering time spent by a first processor in rendering a plurality of historical image frames and corresponding historical operation frequencies, determining status statistics information of the first processor according to the lengths of historical rendering time and the historical operation frequencies, wherein the state statistical information includes expected lengths of rendering time of the first processor under different historical operation frequencies, and controlling a target operation frequency of the first processor when rendering a target image frame to be rendered based on the status statistics information.

### CROSS-REFERENCES TO RELATED APPLICATION

This application claims priority to Chinese Patent Application No. 202411546501.X, filed on Oct. 31, 2024, the entire content of which is incorporated herein by reference.

### FIELD OF TECHNOLOGY

The present disclosure relates to the control technology field and, more particularly, to a control method and a control apparatus.

### BACKGROUND

To reduce power consumption, some electronic devices can adjust a processor operation frequency. In related technologies, electronic devices can adjust the processor operation frequency according to a processor utilization rate over a period of time. For example, if the utilization rate of a graphics processor is high, the operation frequency can be increased. If the utilization rate is low, the operation frequency can be decreased.

The problem with this method is that the utilization rate does not reflect and render the actual loading situation. Thus, when the operation frequency is adjusted according to the utilization rate, the operation frequency and the actual load of the processor may not match. For example, when the processor has a high load, the operation frequency can be lowered, and when the processor has a low load, the operation frequency can be increased.

### SUMMARY

One aspect of this disclosure provides a control method. The method includes obtaining lengths of historical rendering time spent by a first processor in rendering a plurality of historical image frames and corresponding historical operation frequencies, determining status statistics information of the first processor according to the lengths of historical rendering time and the historical operation frequencies, wherein the state statistical information includes expected lengths of rendering time of the first processor under different historical operation frequencies, and controlling a target operation frequency of the first processor when rendering a target image frame to be rendered based on the status statistics information.

Another aspect of this disclosure provides a control apparatus, including an acquisition unit, a determination unit, and a control unit. The acquisition unit is configured to obtain lengths of historical rendering time spent by a first processor in rendering a plurality of historical image frames and corresponding historical operation frequencies. The determination unit is configured to determine status statistics information of the first processor according to the lengths of historical rendering time and historical operation frequencies. The status statistics information includes expected lengths of rendering time of the first processor under different historical operation frequencies. The control unit is configured to control a target operation frequency of the first processor when rendering a target image frame to be rendered based on the status statistics information.

Another aspect of this disclosure provides an electronic device, including one or more processors and one or more memories. The one or more memories store program codes that, when executed by the one or more processors, cause the one or more processors to obtain lengths of historical rendering time spent by a first processor in rendering a plurality of historical image frames and corresponding historical operation frequencies, determine status statistics information of the first processor according to the lengths of historical rendering time and the historical operation frequencies, wherein the state statistical information includes expected lengths of rendering time of the first processor under different historical operation frequencies, and control a target operation frequency of the first processor when rendering a target image frame to be rendered based on the status statistics information.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a control method according to some embodiments of the present disclosure.

FIG. 2 is a schematic diagram of determining a target operation frequency according to some embodiments of the present disclosure.

FIG. 3 is a schematic diagram of determining a length of target rendering time according to some embodiments of the present disclosure.

FIG. 4 is a schematic structural diagram of a control apparatus according to some embodiments of the present disclosure.

### DETAILED DESCRIPTION

The technical solutions of the present disclosure are described in detail in connection with the accompanying drawings of embodiments of the present disclosure. Apparently, the described embodiments are merely some embodiments of the present disclosure, not all embodiments. Based on embodiments of the present disclosure, all other embodiments obtained by those of ordinary skill in the art without creative efforts should be within the scope of the present disclosure.

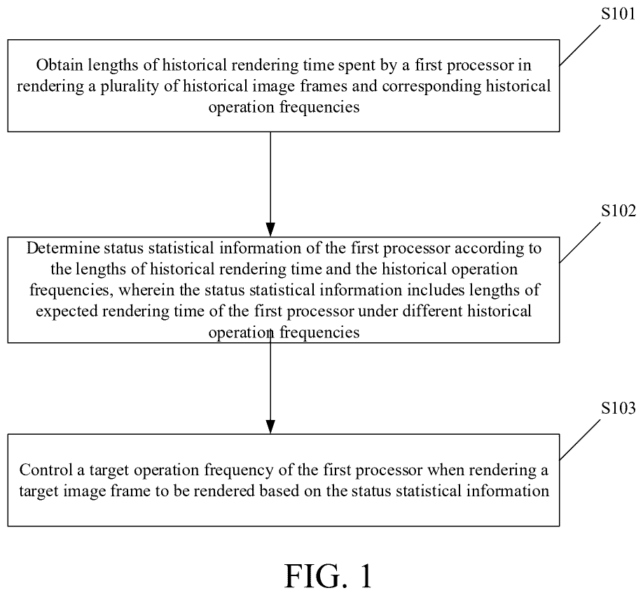

Embodiments of the present disclosure provide a control method. FIG. 1 is a schematic flowchart of a control method according to some embodiments of the present disclosure. The method includes the following processes.

At S101, the length of historical rendering time that a first processor spends in rendering a plurality of historical image frames and the corresponding historical operation frequency are obtained.

The first processor can be a processor in an electronic device configured to render an image frame, for example, a graphics processing unit (GPU). In some embodiments, each time the first processor completes rendering processing of one image frame, the length of rendering time spent by the first processor on rendering the image frame and the operation frequency of the first processor during the rendering of the image frame can be recorded. Then, a length of historical rendering time and a corresponding historical operation frequency of a historical image frame can be obtained. In other words, each historical image frame can correspond to one length of historical rendering time and one historical operation frequency. The length of historical rendering time can be the actual time length that the first processor spent rendering the historical image frame. The historical operation frequency can be the operation frequency of the first processor during the rendering of the historical image frame.

The plurality of historical image frames above can include the historical image frames rendered by the first processor within a nearest certain time length up to the current moment. For example, the plurality of history images can include the historical image frames rendered by the first processor within the last 20 seconds. In some other embodiments, the plurality of historical image frames can include a preset number of historical image frames rendered by the first processor most recently relative to the current moment, for example, 60 historical image frames rendered by the first processor closest to the current moment.

At S102, status statistics information of the first processor is determined according to the length of historical rendering time and the historical operation frequency, where the status statistics information includes an expected length of rendering time of the first processor under different historical operation frequencies.

Each historical operation frequency can correspond to an expected length of rendering time, which can represent the time length spent by the first processor on rendering one image frame according to the historical operation frequency at the current moment.

For example, the historical operation frequencies obtained in process S101 can include 728 MHz and 598 MHz. The determined status statistics information can include that the expected length of rendering time corresponding to 728 MHz can be 10 milliseconds, and the expected length of rendering time corresponding to 598 MHz can be 15 milliseconds, which means that under the current moment, if the first processor renders one image frame according to the operation frequency of 728 MHz, 10 milliseconds can be needed, and if the first processor renders one image frame according to the operation frequency of 598 MHz, 15 milliseconds can be needed.

At S103, based on the state statistical information, the target operation frequency is controlled when the first processor renders a to-be-rendered target image frame.

In general, when other impact factors are ignored, the time length a processor spends rendering an image frame can be inversely related to the operation frequency when the processor renders the image frame. That is, when the operation frequency is higher, the rendering can be faster, and the time length spent can be shorter. When the operation frequency is lower, the rendering can be slower, and the time length spent can be longer. Moreover, when the operation frequency is higher, the power consumption of the processor can be higher. When the operation frequency is lower, the power consumption of the processor can be lower.

Based on the above principle, in process S103, in connection with the expected lengths of rendering time under different historical operation frequencies of the status statistics information, a ratio relationship between the operation frequency and the time length for rendering one image frame of the first processor can be estimated under the current status. Then, based on the ratio relationship and the length of rendering time of the target image frame, a target operation frequency that just satisfies the length of rendering time requirement of the target image frame can be provided. Thus, the first processor can be controlled to render the target image frame according to the target operation frequency.

The method of embodiments of the present disclosure can be executed before each time the first processor starts to render an image frame. In some embodiments, a target operation frequency 1 can be first determined. The first processor can be controlled to render the target image frame 1 according to the target operation frequency 1. Then, a target operation frequency 2 can be determined. The first processor can be controlled to render the target operation frequency 2 according to the target operation frequency 2, and so on.

In some other embodiments, the method of embodiments of the present disclosure can be executed according to a certain target cycle regularly when the first processor renders the plurality of image frames. In some embodiments, target operation frequency 1 can be first determined. Then, the first processor can be controlled in a target cycle to render the plurality of target image frames according to operation frequency 1. Subsequently, the target operation frequency 2 can be determined. The first processor can be controlled according to the target operation frequency 2 in the second target cycle to render the plurality of target image frames, and so on. The target cycle can be set as needed, e.g., 1 s, 500 milliseconds, 100 milliseconds, etc.

The beneficial effects of embodiments of the present disclosure can include that, compared to the method of adjusting the operation frequency according to the utilization rate in the existing technology, with the lengths of historical rendering time of a plurality of historical image frames and the corresponding historical operation frequencies of the present disclosure, the actual load of the first processor can be reflected more correctly. Thus, in the method controlling the operation frequency of the first processor of embodiments of the present disclosure, the power consumption of the first processor can be reduced, and the adjusted operation frequency can be more appropriate to the load of the first processor. The inconsistency between the operation frequency and the actual load can be avoided to a certain degree.

In embodiments of the present disclosure, determining the status statistics information of the first processor according to the length of historical rendering time and the historical operation frequency can include determining a length of historical rendering time of at least one historical image frame corresponding to each historical operation frequency and determining expected lengths of rendering time of the first processor under the historical operation frequencies based on at least one length of historical rendering time.

In some embodiments, for each historical operation frequency, each historical image frame rendered according to the historical operation frequency can be determined. The lengths of historical rendering time corresponding to the historical image frames can be fused to obtain the expected length of rendering time corresponding to the historical operation frequency.

For example, in the plurality of historical image frames, 5 historical image frames can be rendered by the first processor according to frequency 1. The lengths of historical rendering time corresponding to the 5 historical image frames can be fused to obtain the expected length of rendering time corresponding to frequency 1.

The benefit of determining the expected length of rendering time can include that the expected length of rendering time can be determined in connection with the time lengths spent by the first processor to perform a plurality of times of rendering based on the historical operation frequency. Then, the impact of a random factor on the length of historical rendering time can be excluded to a certain degree each time the rendering is performed. Thus, the processing capability of the first processor under the historical operation frequency can be more accurately rated.

In some embodiments, for each historical operation frequency, the historical image frame rendered by the first processor most recently according to the historical operation frequency can be determined from the plurality of historical image frames. The length of historical rendering time corresponding to the historical image frame can be determined as the expected length of rendering time corresponding to the historical operation frequency.

For example, in the plurality of historical image frames, 5 historical image frames rendered by the first processor according to frequency 1 can be provided. The image frame rendered most recently can be image frame 5, the length of historical rendering time of image frame 5 can be determined as the expected length of rendering time of frequency 1. The rendering moment can be a moment when the first processor starts to render an image frame.

Determining the expected length of rendering time according to the above method can include the following benefits. In some embodiments, by determining the expected length of rendering time, the strength of the processing capability of the first processor can be estimated for rendering the target image frames in connection with the historical operation frequency and the corresponding expected length of rendering time. When the length of historical rendering time is further away from the current moment, the length of historical rendering time can have a weaker function to estimate the processing capability of the first processor when rendering the target image frame. When estimation is performed based on the length of historical rendering time that is further away from the current moment, the estimation result can be inaccurate. The length of historical rendering time closest to the current moment can be directly used as the expected length of rendering time. Then, the interference by the length of historical rendering time that is further away from the current moment can be avoided. Based on the recent expected length of rendering time, the strength of the processing capability of the first processor can be better estimated for rendering the target image frame.

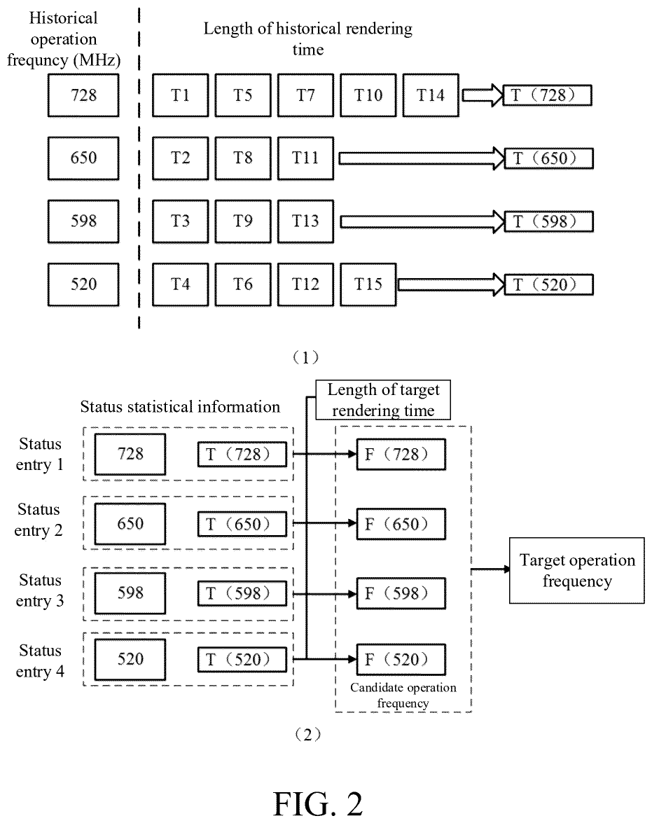

For example, as shown in FIG. 2, assume that lengths of historical rendering time and historical operation frequencies of 15 historical image frames are obtained in process S101. The 15 historical image frames are marked as image frame 1 to image frame 15 according to the rendering sequence. The rendering moment of image frame 1 is the furthest from the current moment, and the rendering moment of image frame 15 is the nearest to the current moment. The length of historical rendering time of each image frame is represented by T. That is, T1 is the length of historical rendering time of image frame 1, T2 is the length of historical rendering time of image frame 2, and so on.

In this example, as shown in FIG. 2(1), assume that image frame 1, image frame 5, image frame 7, image frame 10, and image frame 14 correspond to the historical operation frequency of 728 MHz. That is, 728 MHz corresponds to lengths of historical rendering time T1, T5, T7, T10, and T14.

Image frame 2, image frame 8, and image frame 11 correspond to the historical operation frequency 650 MHz. That is, 650 MHz corresponds to lengths of historical rendering time T2, T8, and T11.

Image frame 3, image frame 9, and image frame 13 correspond to the historical operation frequency of 598 MHz. That is, 598 MHz corresponds to lengths of historical rendering time T3, T9, and T13.

Image frame 4, image frame 6, image frame 12, and image frame 15 correspond to the historical operation frequency of 520 MHz. That is, 520 MHz corresponds to lengths of historical rendering time T4, T6, T12, and T15.

As shown in FIG. 2(1), when the status statistics information is determined, T1, T5, T7, T10, and T14 are fused to obtain the expected length of rendering time T(728) corresponding to 728 MHz. T2, T8, and T11 are fused to obtain the expected length of rendering time T(650) corresponding to 650 MHz. T3, T9, and T13 are fused to obtain the expected length of rendering time T(598) corresponding to 598 MHz. T4, T6, T12, and T15 are fused to obtain the expected time length corresponding to 520 MHz.

Fusing the plurality of lengths of historical rendering time to obtain the expected length of rendering time can include calculating an average value of the plurality of lengths of historical rendering time and using the result as the expected length of rendering time. Based on the above, the average value of T2, T8, and T11 can be determined as the expected length of rendering time corresponding to 650 MHz, i.e., T(650)=(T2+T8+T11)/3.

In some embodiments, fusing the plurality of lengths of historical rendering time to obtain the expected length of rendering time can include, for each historical operation frequency, determining time length weights of the lengths of historical rendering time under the historical operation frequency according to the rendering moments of the first processor for the plurality of historical image frames corresponding to the historical operation frequency, and determining expected length of rendering time of the first processor under the historical operation frequency according to the plurality of lengths of historical rendering time and the time length weights corresponding to the lengths of historical rendering time.

In the above embodiments, each historical image frame can correspond to a rendering moment. The rendering moment can be the moment when the first processor starts to render the historical image frame.

When the time length weights are determined, for each length of historical rendering time, the time length weight of the length of historical rendering time can be determined according to the distance between the rendering moment of the historical image frame corresponding to the length of historical rendering time and the current moment. When the rendering moment is further from the current moment, the corresponding time length weight can be smaller, and when the rendering moment is closer to the current moment, the corresponding time length weight can be larger.

Various methods can be provided to determine the time length weights, which are not limited.

For example, the time from the rendering moment to the current moment can be divided by a preset value, and the result obtained by subtracting the ratio by 1 can be used as the time length weight. Exemplarily, the time from the rendering moment of the length of historical rendering time to the current moment can be 160 s. The time length weight of the length of historical rendering time can be 1-160/200.

For example, when the rendering moment is further from the current moment, the corresponding time length weight can be smaller. By ensuring that the sum of the weights of the lengths of historical rendering time corresponding to the same historical operation frequency equals 1, the time length weights of the lengths of historical rendering time can be proportionally determined.

For example, a distance sum can be obtained by calculating the sum of the distances corresponding to the lengths of historical rendering time (i.e., distances from the rendering moments to the current moment). For each length of historical rendering time, the distance corresponding to the length of historical rendering time can be divided by the distance sum to obtain a ratio as the time length weight of the length of historical rendering time.

After the time length weight is determined, for each historical operation frequency, the weighted sum of the plurality of lengths of historical rendering time corresponding to the historical operation frequency can be calculated according to the respective time length weights to obtain a result as the expected length of rendering time corresponding to the historical operation frequency.

In combination with the example in FIG. 2, among the three historical image frames corresponding to 598 MHz, the rendering moment of image frame 3 is the farthest from the current moment, the rendering moment of image frame 9 is the second farthest, and the rendering moment of image frame 13 is the closest to the current moment. Thus, the time length weight of length of historical rendering time T3 can be determined as 1/6, the time length weight of length of historical rendering time T9 can be determined as 2/6, and the time length weight of length of historical rendering time T13 can be determined as 3/6. Then, the expected length of rendering time of 598 MHz can be calculated according to the following formula.

$$T ( 598 ) = 1 / 6 * T 3 + 2 / 6 * T 9 + 3 / 6 * T 13.$$

The advantage of fusing the lengths of historical rendering time according to the above method can be as follows. Generally, when the historical image frame is closer to the current moment, the load situation of the first processor reflected by the historical operation frequency and the length of historical rendering time of the historical image frame can be close to the actual load situation of the first processor at the current moment. When the historical image frame is further from the current moment, the load situation of the first processor reflected by the historical operation frequency and the length of historical rendering time of the historical image frame can deviate from the actual load situation of the first processor of the current moment. The different lengths of historical rendering time can be weighted according to the distances of the rendering moment to the current moment. The obtained historical operation frequency and the expected length of rendering time corresponding to the historical operation frequency can be more appropriate to the actual load situation of the first processor. Thus, a more accurate target operation frequency can be obtained.

In some embodiments, as shown in FIG. 2(2), the status statistics information includes a plurality of status entries. Each status entry includes a historical operation frequency and the expected length of rendering time corresponding to the historical operation frequency.

Each status entry can reflect the processing capability of the first processor at the frequency of that entry. The processing capability can be represented by the product of the historical operation frequency and the expected length of rendering time in the entry. When the product is larger, the processing capability can be stronger. When the product is smaller, the processing capability can be weaker.

Generally, within a short period of time, the processing capability of the first processor can be considered basically unchanged. Under the premise of processing capability being unchanged, the operation frequency of the first processor can be negatively related to the time length spent to render one image frame.

In some embodiments, determining the target operation frequency according to the status statistics information can include obtaining the length of target rendering time used to render the target image frame and determining, according to the length of target rendering time and the status entries contained in the status statistics information, the target operation frequency of the first processor when rendering the target image frame.

The length of target rendering time can represent the time the first processor needs to complete rendering a target image frame. For example, if the length of target rendering time is 10 milliseconds, it means the first processor needs to render a target image frame within 10 milliseconds.

In some embodiments, according to the processing capabilities reflected by the status entries and the length of target rendering time, the corresponding processing capability can be determined. The operation frequency needed by the first processor to finish rendering one target image frame within the length of target rendering time can be the target operation frequency.

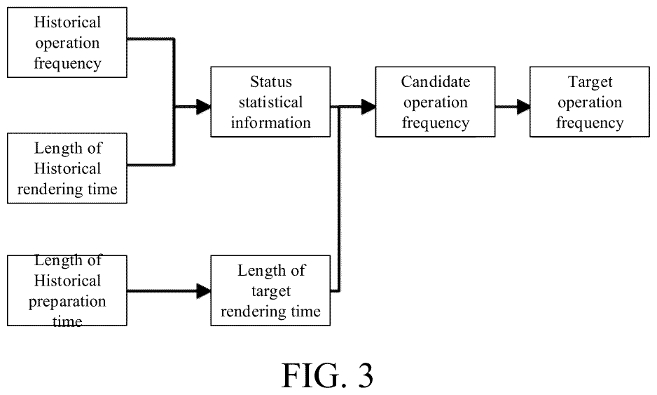

As shown in FIG. 3, obtaining the length of target rendering time includes obtaining a length of historical preparation time used by a historical rendering task corresponding to the historical image frame provided by the second processor, the second processing being configured to provide the rendering task to the first processor to trigger the first processor to render the image frame based on the rendering task, and determining the length of target rendering time for rendering the target image frame according to the length of historical preparation time.

The second processor can be another processor different from the first processor of the electronic device. For example, the second processor can be a central processing unit (CPU) of the electronic device.

The second processor can be configured to control the first processor to render to obtain the image frame. The second processor can obtain various types of input data required for rendering an image frame through a running program, e.g., obtaining materials needed for rendering, and rendering-related parameters. The data can be packaged as a rendering task. Then, the second processor can provide the rendering task to the first processor to trigger the first processor for rendering using the input data included in the rendering task to obtain an image frame.

The time length for the second processor to obtain a rendering task and provide the rendering task to the first processor can be referred to as the preparation time length of the rendering task. For each historical image frame, the time length for the second processor to obtain and provide the corresponding historical rendering task to the first processor can be the length of historical preparation time of the historical rendering task.

After the plurality of length of historical preparation times are obtained, the preparation length corresponding to a next rendering task can be estimated according to the plurality of length of historical preparation times. The estimated preparation time length of the next rendering task can be determined as the length of target rendering time of the target image frame.

In embodiments of the present disclosure, the rendering task corresponding to the target image frame can be marked as the target rendering task. The next rendering task can include the next rendering task that the second processor prepares to output to the first processor when the second processor outputs the target rendering task.

The estimated preparation time length can be used as the length of target rendering time to allow the first processor to rendering the target image frame corresponding to the target rendering task as much as possible before the first processor receives a new rendering task (i.e., the next rendering task), which can avoid stutter in the rendering process caused by the first processor spending too long rendering the target image frame.

Estimating the preparation time length corresponding to the next rendering task according to the length of historical preparation time can include calculating an average value of the plurality of length of historical preparation times as the estimated preparation time length, or determining corresponding weights for the plurality of length of historical preparation times according the rendering moments and determining the estimated preparation time length by calculating the weighted sum based on the weights.

In some other embodiments, obtaining the length of target rendering time can include obtaining configuration parameters corresponding to the target image frame, and determining the length of target rendering time of the target image frame according to the configuration parameters.

The configuration parameters corresponding to the target image frame can include configuration parameters specified by an application for generating the target rendering task corresponding to the target image frame and the configuration parameters of the electronic device when rendering the target image frame. The configuration parameters of embodiments of the present disclosure can be used to control how many image frames the electronic device can display in sequence within a unit time. For example, the configuration parameters can include frame rate, refresh rate, or other similar parameters.

For example, when the user uses a gaming application installed in the electronic device, the GPU can perform rendering based on the rendering tasks of the gaming application provided by the CPU in sequence to obtain a plurality of image frames and provide the plurality of image frames to the screen for display frame by frame. In some embodiments, if the frame rate determined by the gaming application is 90 fps, the configuration parameters corresponding to the target image frame can include the determined frame rate of 90 fps of the gaming application.

For another example, when the GPU renders the image frame, the electronic device can be in an energy-saving mode. The electronic device can restrict the frame rate of the screen to 30 fps. Then, the configuration parameter corresponding to the target image frame can include the frame rate of 30 fps of the screen.

In some embodiments, the length of target rendering time required to satisfy the configuration parameter can be calculated according to the configuration parameters. For example, the configuration parameter can include the frame rate. If the frame rate is 60 fps, the time length spent each time rendering the image frame on average cannot exceed 1/60 s to satisfy the frame rate. Thus, the target time length can be determined as 1/60 s. Similarly, if the configuration parameter includes the frame rate 90 fps, the length of target rendering time can be 1/90 s.

As shown in FIG. 2(2), after obtaining the length of target rendering time, determining the target operation frequency according to the length of target rendering time and the status entries includes, for each status entry and the length of target rendering time, determining the candidate operation frequency corresponding to each status entry, and according to candidate operation frequencies corresponding to the plurality of status entries, determining the target operation frequency of the first processor when rendering the target image frame.

For each status entry, a candidate operation frequency can be determined according to the status entry and the length of target rendering time. The candidate operation frequency can be the lowest frequency required by the first processor to finish rendering the target image frame within the length of target rendering time, when the first processor is under the processing capability represented by the status entry.

In some embodiments, for each status entry, determining the corresponding candidate operation frequency can include multiplying the historical operation frequency of the status entry and the estimated length of rendering time to obtain a result, dividing the result by the length of target rendering time to obtain a result as the candidate operation frequency corresponding to the status entry, That is, candidate operation frequency=historical operation frequency×estimated length of rendering time÷length of target rendering time.

According to FIG. 2(2), for status entry 1 corresponding to 728 MHz, the candidate operation frequency F(728) can be calculated by the following formula. F(728)=728 MHz×T(728)÷T_{target}. T_{target} represent the length of target rendering time.

Determining the target operation frequency according to the plurality of candidate operation frequencies can include determining the average value of the plurality of candidate operation frequencies as the target operation frequency.

In some other embodiments, determining the target operation frequency according to the plurality of candidate operation frequencies can include obtaining a status parameter corresponding to each status entry and determining the target operation frequency of the first processor when rendering the target image frame according to the status parameter of the plurality of status entries and the candidate operation frequency.

The status parameter can include at least one of a time parameter, a load parameter, or a frequency parameter.

In some embodiments, for each status entry, the weight of the status entry can be determined based on the status parameter of the status entry. A weighted sum can be performed on the candidate operation frequencies of the status entries based on the weights of the status entries to obtain a result as the target operation frequency.

As an example, the time parameter of the status entry can be determined as follows. The rendering moments for rendering the plurality of historical image frames according to the frequency included in the status entry can be obtained. The distance between the rendering moment closest to the current moment and the current moment (the time length between two moments) can be determined as the time parameter of the status entry. In connection with the examples shown in FIG. 2, for status entry 1, among the image frames that are rendered according to the frequency included in the item, the rendering moment of the image frame 14 is closest to the current moment. The distance between the rendering moment of the image frame and the current moment can be determined as the time parameter of the status entry 1.

When the status parameter is determined according to the method of embodiments of the present disclosure, the status parameter can be inversely correlated with the weight. That is, when the status parameter of a status entry is larger, the corresponding weight can be smaller, and when the status parameter of the status entry is smaller, the corresponding weight can be larger.

As another example, determining a load parameter of a status entry can include determining the actual frame rate of the first processor when the first processor renders the historical image frame according to the frequency included in the status entry, or obtaining the average frame rate when the first processor renders the plurality of historical image frames according to the frequency included in the status entry and determining the absolute value of the difference between the actual frame rate (or average frame rate) and the actual frame rate of the first processor at the current moment as the load parameter of the status entry.

In connection with the examples of FIG. 2, for the status entry 2, the actual frame rate of the first processor rendering the image frame 2, the actual frame rate of the first processor rendering the image frame 8, and the actual frame rate of the first processor rendering the image frame 11 are obtained. The average frame rate corresponding to the status entry 2 can be obtained by calculating the average value of the three actual frame rates. The difference between the average frame rate and the actual frame rate of the first processor at the current moment can be calculated, and the absolute value of the difference can be used as the load parameter of the status entry 2.

The load parameter determined according to the above method can reflect the load situation when the first processor renders the historical image frame according to the frequency included in the status entry and the deviation degree of the load situation of the current moment. If the load parameter is smaller, the deviation degree can be smaller. Thus, the difference between the processing capability represented by the status entry and the actual processing capability of the first processor at the current moment can be small. Then, a relatively large weight can be set for the status entry. If the load parameter is larger, the difference between the processing capability represented by the status entry and the actual processing capability of the first processor can be larger. Then, a relatively small weight can be set for the status entry.

For example, determining a frequency parameter of a status entry can include calculating a difference between the historical operation frequency included in the status entry and the current operation frequency of the first processor and using the absolute value of the obtained difference as the frequency parameter corresponding to the status entry.

In general, when the corresponding historical operation frequency is close to the current operation frequency of the first processor, the status entry can accurately represent the current processing capability of the first processor. When the corresponding historical operation frequency has a big difference from the current operation frequency, the accuracy of the current processing capability of the first processor represented by the status entry can be reduced.

Thus, when the frequency parameter of the status entry is large, the processing capability represented by the status entry can have a big difference from the current actual processing capability of the first processor. A small weight can be set for the status entry. When the frequency parameter of the status entry is small, the processing capability represented by the status entry can have a small difference from the current actual processing capability of the first processor. A large weight can be set for the status entry.

In some embodiments, the electronic device can perform the method of embodiments of the present disclosure when satisfying a specific trigger condition. That is, process S101 can include, in response to detecting the trigger condition, obtaining the length of historical rendering time spent by the first processor on rendering the plurality of historical image frames and the corresponding historical operation frequency.

Detecting the trigger condition can include at least one of first, detecting a frequency control instruction for controlling the operation frequency of the first processor, second, detecting the electronic device to which the first processor belongs starts the target application, third, detecting that the power of the electronic device is lower than a power threshold, and fourth, detecting that the electronic device is in the target operation status.

In the first trigger condition, the electronic device can obtain the frequency control instruction based on the operation of the user. For example, the user can perform an operation of adjusting the operation frequency of the first processor through a physical key or a related system operation interface when the user finds that the electronic device is excessively hot, screen freezes, or other abnormal situations. The electronic device can obtain the frequency control instruction based on the operation. The electronic device can obtain the frequency control instruction based on the operation to control the operation frequency of the first processor according to the method of embodiments of the present disclosure.

In the second trigger condition, the electronic device can determine one or more target applications based on the application types of different applications, user use habits, and configuration parameters. For example, the gaming application and the video application can be determined as the target applications. The electronic device can determine the application that is often used by the user as the target application. The electronic device can determine the application with a higher image frame rate during operation as the target application. In some other embodiments, the electronic device can determine the one or more applications specified by the user as the target applications. Then, when any one target application is detected to be started, the electronic device can control the operation frequency of the first processor according to the method of embodiments of the present disclosure.

In the third trigger condition, the electronic device can determine a power threshold based on the user setting, plant setting, or user use habit. When the power is lower than the power threshold, the electronic device can control the operation frequency of the first processor according to the method of embodiments of the present disclosure to lower the power consumed by the device as much as possible.

In the fourth trigger condition, the electronic device can have various operation statuses, such as a high-performance status, a normal status, and a power-saving status. In the high-performance status, the screen of the electronic device can display an image at a relatively high refresh rate.

The target operation status can include the high-performance status. The electronic device can execute the method of embodiments of the present disclosure when detecting the high-performance status to utilize the performance of the first processor as much as possible to meet the demands of the high-performance status.

The target operation status can also include the power-saving status. The electronic device can execute the method of embodiments of the present disclosure when detecting the power-saving status to reduce power consumption by dynamically controlling the operation frequency.

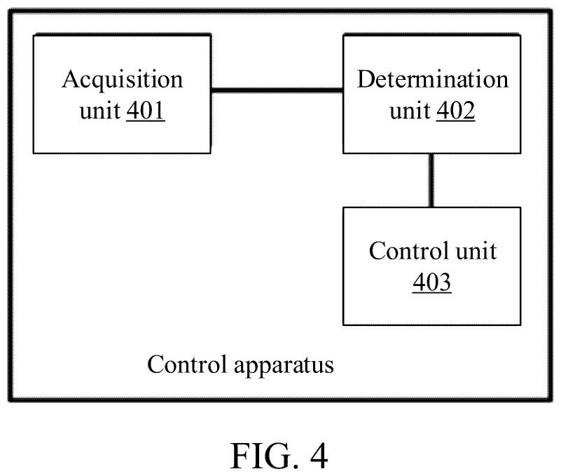

Embodiments of the present disclosure further provide a control apparatus. FIG. 4 is a schematic structural diagram of the control apparatus according to some embodiments of the present disclosure. The apparatus includes an acquisition unit 401, a determination unit 402, and a control unit 403.

The acquisition unit 401 can be configured to obtain the lengths of historical rendering time spent by the first processor in rendering the plurality of historical image frames and the corresponding historical operation frequencies.

The determination unit 402 can be configured to determine the status statistics information of the first processor according to the lengths of historical rendering time and historical operation frequencies. The status statistics information can include expected lengths of rendering time of the first processor at different historical operation frequencies.

The control unit 403 can be configured to control the target operation frequency when the first processor renders a target image frame to be rendered based on the status statistics information.

In some embodiments, when determining the status statistics information of the first processor according to the lengths of historical rendering time and historical operation frequencies, the determination unit 402 can be configured to determine the length of historical rendering time of at least one historical image frame corresponding to each historical operation frequency, and determine the expected lengths of rendering time of the first processor at the historical operation frequencies based on the at least one length of historical rendering time.

In some embodiments, when determining the expected lengths of rendering time of the first processor at the historical operation frequencies based on the at least one length of historical rendering time, the determination unit 402 can be configured to, for each historical operation frequency, determine time length weights of the lengths of historical rendering time corresponding to the historical operation frequency according to the rendering moments of the first processor for the plurality of historical image frames corresponding to the historical operation frequency, and determine the expected length of rendering time of the first processor under the historical operation frequency according to the plurality of lengths of historical rendering time and the time length weights corresponding to the length of historical rendering time.

In some embodiments, the status statistics information can include a plurality of status entries. Each status entry can include a historical operation frequency and the expected length of rendering time corresponding to the historical operation frequency.

When controlling the target operation frequency when the first processor renders the target image frame to be rendered based on the status statistics information, the control unit 403 can be configured to obtain the length of target rendering time for rendering the target image frame and determining the target operation frequency of the first processor when rendering the target image frame according to the length of target rendering time and the status statistics information.

In some embodiments, when obtaining the length of target rendering time for rendering the target image frame, the control unit 403 can be configured to obtain the length of historical preparation time of the historical rendering task corresponding to the historical image frame provided by the second processor, the second processor being configured to provide a rendering task to the first processor to trigger the first processor to render the image frame based on the rendering task, and determine the length of target rendering time for rendering the target image frame according to the length of historical preparation time.

In some embodiments, when obtaining the length of target rendering time for rendering the target image frame, the control unit 403 can be configured to obtain the configuration parameter corresponding to the target image frame and determine the length of target rendering time for rendering the target image frame according to the configuration parameter.

In some embodiments, when determining the target operation frequency of the first processor when rendering the target image frame according to the length of target rendering time and the status statistics information, the control unit 403 can be configured to, for each status entry and the length of target rendering time, determine the candidate operation frequency corresponding to each status entry, and determine the target operation frequency of the first processor when rendering the target image frame according to the candidate operation frequencies corresponding to the plurality of status entries.

In some embodiments, when determining the target operation frequency of the first processor in rendering the target image frame according to the candidate operation frequencies corresponding to the plurality of status entries, the control unit 403 can be configured to obtain the status parameter corresponding to each status entry, and determining the target operation frequency of the first processor in rendering the target image frame according to the status parameter and the candidate operation frequencies of the plurality of status entries.

In some embodiments, when obtaining the length of historical rendering time spent by the first processor for rendering the plurality of historical image frames and the corresponding historical operation frequencies, the acquisition unit 401 can be configured to, in response to detecting the trigger condition, obtaining the length of historical rendering time spent by the first processor for rendering the plurality of historical image frames and the corresponding historical operation frequencies. Detecting the trigger condition can include at least one of detecting a frequency control instruction for controlling the operation frequency of the first processor, detecting that the electronic device where the first processor belongs starts the target application, detecting that the power of the electronic device is lower than the power threshold, or detecting that the electronic device is in the target operation status.

For the operation principle of the control apparatus of embodiments of the present disclosure, reference can be made to related processes of the control method of embodiments of the present disclosure, which is not repeated.

Embodiments of the present disclosure are described in a progressive manner. Each embodiment focuses on the differences from other embodiments. The identical or similar parts among embodiments of the present disclosure can refer to each other.

To facilitate the description, when describing the above system or apparatus, various modules or units divided by functions can be described separately. Of course, when the present disclosure is implemented, the functions of the units can be realized in a same or plurality of pieces of software and/or hardware.

Through the description of embodiments of the present disclosure, those skilled in the art can know that the present disclosure can be realized by software plus a necessary hardware platform. Based on this understanding, the technical solution of the present disclosure, in essence, or the part that contributes to the existing technology, can be embodied in the form of a software product. The computer software product can be stored in a storage medium, such as a ROM/RAM, magnetic disk, optical disk, etc., and includes several instructions for enabling a computer device (e.g., a personal computer, a server, a network device, etc.) to execute the method described in various embodiments or in certain parts of embodiments of the present disclosure.

Finally, in the present disclosure, relational terms such as “first,” “second,” “third,” and “fourth” are merely used to distinguish one entity or operation from another entity or operation, and do not necessarily require or imply any such actual relationship or sequence between these entities or operations. Moreover, the terms “include,” “comprise,” or any other variations thereof are intended to cover non-exclusive inclusion, so that a process, method, article, or device that includes a series of elements not only includes those elements but may also include other elements not explicitly listed, or further includes elements inherent to such process, method, article, or device. Without further limitation, an element defined by the statement “including a . . . ” does not exclude the existence of other identical elements in a process, method, article, or device that includes the element.

The above descriptions are merely some embodiments of the present disclosure. For those of ordinary skill in the art, modifications and refinements can be made without departing from the principles of the present disclosure, and these modifications and refinements shall also be within the scope of the present disclosure.

What is claimed is:

1. A control method, comprising:
obtaining lengths of historical rendering time spent by a first processor in rendering a plurality of historical image frames and corresponding historical operation frequencies;
determining status statistics information of the first processor according to the lengths of historical rendering time and the historical operation frequencies, wherein the state statistical information includes expected lengths of rendering time of the first processor under different historical operation frequencies; and
controlling a target operation frequency of the first processor when rendering a target image frame to be rendered based on the status statistics information.

2. The method according to claim 1, wherein determining the status statistics information of the first processor according to the lengths of historical rendering time and the historical operation frequencies includes:
determining a length of historical rendering time corresponding to at least one historical image frame for each historical operation frequency; and
determining expected lengths of rendering time of the first processor under the historical operation frequencies based on the at least one length of historical rendering time.

3. The method according to claim 2, wherein determining the expected lengths of rendering time of the first processor under the historical operation frequencies based on the at least one length of historical rendering time includes:
for each historical operation frequency, according to rendering moments of the first processor for the corresponding plurality of historical image frames under the historical operation frequency, determining time length weights of the corresponding lengths of historical rendering time under the historical operation frequency; and
determining the expected length of rendering time of the first processor under the historical operation frequency according to the plurality of lengths of historical rendering time and the time length weights of the lengths of historical rendering time.

4. The method according to claim 1, wherein:
the status statistics information includes a plurality of status entries, and each status entry includes a historical operation frequency and an expected length of rendering time corresponding to the historical operation frequency; and
controlling the target operation frequency of the first processor when rendering the target image frame to be rendered based on the status statistics information includes:
obtaining a length of target rendering time for rendering the target image frame; and
determining the target operation frequency of the first processor when rendering the target image frame according to the length of target rendering time and the status entries included in the status statistics information.

5. The method according to claim 4, wherein obtaining the length of target rendering time for rendering the target image frame includes:
obtaining a length of historical preparation time spent by a second processor for providing a historical rendering task corresponding to the historical image frame, wherein the second processor is configured to provide a rendering task to the first processor to trigger the first processor to render an image frame based on the rendering task; and
determining the length of target rendering time for rendering the target image frame according to the length of historical preparation time.

6. The method according to claim 4, wherein obtaining the length of target rendering time for rendering the target image frame includes:
obtaining a configuration parameter corresponding to the target image frame; and
determining the length of target rendering time for rendering the target image frame according to the configuration parameter.

7. The method according to claim 4, wherein determining the target operation frequency of the first processor when rendering the target image frame according to the length of target rendering time and the status entries included in the status statistics information includes:
for each status entry and the length of target rendering time, determining a candidate operation frequency corresponding to each status entry; and
determining the target operation frequency of the first processor when rendering the target image frame according to the candidate operation frequencies corresponding to the plurality of status entries.

8. The method according to claim 7, wherein determining the target operation frequency of the first processor when rendering the target image frame according to the candidate operation frequencies corresponding to the plurality of status entries includes:
obtaining a status parameters corresponding to each status entry; and
determining the target operation frequency of the first processor when rendering the target image frame according to the status parameters and the candidate operation frequencies of the plurality of status entries.

9. The method according to claim 1, wherein obtaining the lengths of historical rendering time spent by the first processor in rendering the plurality of historical image frames and the corresponding historical operation frequencies includes:
in response to detecting a trigger condition, obtaining the lengths of historical rendering time spent by the first processor in rendering the plurality of historical image frames and the corresponding historical operation frequencies;
wherein detecting the trigger condition includes at least one of:
detecting a frequency control instruction for controlling the operation frequency of the first processor;
detecting that an electronic device to which the first processor belongs starts a target application;
detecting that power of the electronic device is lower than a power threshold; or
detecting that the electronic device is in a target operation status.

10. A computer-readable storage storing program codes that, when executed by one or more processors, cause the one or more processors to:
obtain lengths of historical rendering time spent by a first processor in rendering a plurality of historical image frames and corresponding historical operation frequencies;
determine status statistics information of the first processor according to the lengths of historical rendering time and the historical operation frequencies, wherein the state statistical information includes expected lengths of rendering time of the first processor under different historical operation frequencies; and
control a target operation frequency of the first processor when rendering a target image frame to be rendered based on the status statistics information.

11. An electronic device comprising:
one or more processors; and
one or more memories storing program codes that, when executed by the one or more processors, cause the one or more processors to:
obtain lengths of historical rendering time spent by a first processor in rendering a plurality of historical image frames and corresponding historical operation frequencies;
determine status statistics information of the first processor according to the lengths of historical rendering time and the historical operation frequencies, wherein the state statistical information includes expected lengths of rendering time of the first processor under different historical operation frequencies; and
control a target operation frequency of the first processor when rendering a target image frame to be rendered based on the status statistics information.

12. The device according to claim 11, wherein the one or more processors are further configured to:
determine a length of historical rendering time corresponding to at least one historical image frame for each historical operation frequency; and
determine expected lengths of rendering time of the first processor under the historical operation frequencies based on the at least one length of historical rendering time.

13. The device according to claim 12, wherein the one or more processors are further configured to:
for each historical operation frequency, according to rendering moments of the first processor for the corresponding plurality of historical image frames under the historical operation frequency, determine time length weights of the corresponding lengths of historical rendering time under the historical operation frequency; and
determine the expected length of rendering time of the first processor under the historical operation frequency according to the plurality of lengths of historical rendering time and the time length weights of the lengths of historical rendering time.

14. The device according to claim 11, wherein:
the status statistics information includes a plurality of status entries, and each status entry includes a historical operation frequency and an expected length of rendering time corresponding to the historical operation frequency; and
the one or more processors are further configured to:
obtain a length of target rendering time for rendering the target image frame; and
determine the target operation frequency of the first processor when rendering the target image frame according to the length of target rendering time and the status entries included in the status statistics information.

15. The device according to claim 14, wherein the one or more processors are further configured to:
obtain a length of historical preparation time spent by a second processor for providing a historical rendering task corresponding to the historical image frame, wherein the second processor is configured to provide a rendering task to the first processor to trigger the first processor to render an image frame based on the rendering task; and
determine the length of target rendering time for rendering the target image frame according to the length of historical preparation time.

16. The device according to claim 14, wherein the one ore more processors are further configured to:
obtain a configuration parameter corresponding to the target image frame; and
determine the length of target rendering time for rendering the target image frame according to the configuration parameter.

17. The device according to claim 14, wherein the one ore more processors are further configured to:
for each status entry and the length of target rendering time, determine a candidate operation frequency corresponding to each status entry; and
determine the target operation frequency of the first processor when rendering the target image frame according to the candidate operation frequencies corresponding to the plurality of status entries.

18. The device according to claim 17, wherein the one or more processors are further configured to:
obtain a status parameter corresponding to each status entry; and
determine the target operation frequency of the first processor when rendering the target image frame according to the status parameters and the candidate operation frequencies of the plurality of status entries.

19. The device according to claim 11, wherein the one or more processors are further configured to:
in response to detecting a trigger condition, obtain the lengths of historical rendering time spent by the first processor in rendering the plurality of historical image frames and the corresponding historical operation frequencies;
wherein detecting the trigger condition includes at least one of:
detecting a frequency control instruction for controlling the operation frequency of the first processor;
detecting that an electronic device to which the first processor belongs starts a target application;
detecting that power of the electronic device is lower than a power threshold; or
detecting that the electronic device is in a target operation status.
